(19) United States
(12) Patent Application Publication
(10) Pub. No.: US 2021/0012988 A1
(43) Pub. Date: Jan. 14, 2021

(54) RELAY CONTROL DEVICE FOR A RELAY MODULE

(71) Applicant: SCHNEIDER ELECTRIC ASIA PTE LTD, Singapore (SG)

(72) Inventor: Didier SEVERAC, Singapore (SG)

(73) Assignee: Schneider Electric Asia Pte Ltd, Singapore (SG)

(21) Appl. No.: 16/971,853

(22) PCT Filed: Jan. 7, 2019
(86) PCT No.: PCT/SG2019/050010

§ 371 Date: Aug. 21, 2020

(30) Foreign Application Priority Data
Feb. 28, 2018 (SG) 10201801656Y

(51) Int. Cl. H01H 50/04; H01H 50/54; H01H 50/44; H01H 50/64; H01H 50/20; H01H 50/18

(52) U.S. Cl. CPC H01H 50/041; H01H 50/541; H01H 50/44; H01H 2050/446; H01H 50/20; H01H 50/18; H01H 2050/046; H01H 50/641

(57) ABSTRACT

A relay control device for a relay module and a relay module are provided, the relay control device comprising, one or more docks, each dock specifically adapted to mate with a modular contact device and comprising a first mating portion for the mating; one or more power terminals for coupling an energy source to energise the relay control device; an electromagnet disposed in a housing of the relay control device, the electromagnet comprising an electromagnetic coil; and a core, wherein the electromagnetic coil and the core are configured to cooperate with each other upon energization of the relay control device to provide a push mechanism of the relay control device to switch a state of at least one modular contact device.

### TECHNICAL FIELD

The present disclosure relates broadly to a relay control device for a relay module and a relay module.

### BACKGROUND

Relays or relay switches are typically used to operate machinery and circuits. Typically, such relays are connected to a socket and the relays are controlled via the socket by energization of relay cons in the relays. Such relays typically rely on energization or switching on/off for operations. Typically, a relay switch comprises an electromagnet with a soft iron bar and an armature. A contact/switch is coupled to the armature such that the contact is held in its default position by e.g. a return spring. Typically, when the electromagnet is energized, by e.g. a user applying a power source to the relay, a magnetic force overcomes the biasing force provided by the return spring and moves the contact into an alternative position, such that the circuit is either open or connected. When the electromagnet is de-energized, by e.g. a user removing the power source to the relay, the contact returns to and is held in its default position by the return spring. The default positions are typically termed as normally open (NO) or normally closed (NC) such that energization of the relay switches the default position, e.g. a NO switch becomes closed,

Presently, relays typically have a fixed number of contacts. Typically, to increase the number of contacts, a user utilizes multiple relays. This may increase costs to the users.

Further, due to the fixed number of contacts in a relay, a user has to determine the number of contacts needed for the machinery or circuit before purchasing a relay. Such planning may involve deciding the type of relay switches to purchase e.g. a two-pole relay, a three-pole relay etc. This causes inflexibility, for example, during the planning stage of a project.

In addition, a relay is typically designed to incorporate more than one NO and/or NC contacts. Such a typical relay allows for single arc breaking and is recognized to have relatively poor electrical separation between e.g. NO and NC contacts due to the sharing of a common wire for such contacts. It is also recognized that the ability to break an electrical current is weak due to the single arc breaking.

Furthermore, it has been observed that repeated usage of the contacts of a relay typically wears down the contacts i.e. wear and tear. In such circumstances, a relay with a damaged electrical contact has to be replaced entirely. This may be even though none of the other components of the relay e.g. the electromagnet is damaged. Such replacement increases the costs for a user.

Therefore, there exists a need to provide a relay control device for a relay module and a relay module that seek to address one or more of the problems above.

### SUMMARY

In accordance with an aspect, there is provided a relay control device for a relay module, the relay control device comprising, one or more docks, each dock specifically adapted to mate with a modular contact device and comprising a first mating portion for the mating; one or more power terminals for coupling an energy source to energise the relay control device; an electromagnet disposed in a housing of the relay control device, the electromagnet comprising an electromagnetic coil; and a core, wherein the electromagnetic coil and the core are configured to cooperate with each other upon energization of the relay control device to provide a push mechanism of the relay control device to switch a state of at least one modular contact device.

The push mechanism may be configured to interact with an actuating arm of the at least one modular contact device to switch the state of the at least one modular contact device.

The core may be located at a stationary position in the relay control device; and the electromagnetic coil may be configured to be movable with respect to the core from a default position when the relay control device switches between an energized state and a de-energized state to provide the push mechanism.

The electromagnet may be located at a stationary position in the relay control device; and the core may be configured to be movable with respect to the electromagnetic coil from a default position when the relay control device switches between an energized state and a de-energized state to provide the push mechanism.

The relay control device may further comprise a recess disposed in the housing, the recess extending across the one or more docks and being adapted to -allow the push mechanism to switch the state of the at least one modular contact device.

For each dock, an aperture may be disposed in the housing and adapted to allow the push mechanism to switch the state of the at least one modular contact device.

The first mating portion may comprise an aperture disposed on a surface of the housing and configured to mate with a corresponding appendage of said modular contact device.

The dock may further comprise a second mating portion disposed on the housing,

The second mating portion may comprise at least two sidewalls of the housing configured to engage with a corresponding catch of said modular contact device.

In accordance with another aspect, there is provided a relay module comprising: a relay control device as disclosed herein; and at least one modular contact device detachably coupled to the relay control device, the modular contact device comprising: an actuating arm disposed to interact with the push mechanism of the relay control device.

The actuating arm may be configured to be displaced by the push mechanism to switch the state of the at least one modular contact device.

The at least one modular contact device may further comprise a protruding appendage adapted to mate with the first mating portion of the corresponding dock of the relay control device.

The modular contact device may further comprise a two-legged catch for additionally detachably coupling to the corresponding dock of the relay control device.

The actuating arm may be configured to provide a switch in the state of the modular contact device based on a displacement of the actuating arm.

The at least one modular contact device may further comprise a spring member capable of returning the electromagnetic coil or the core of the relay control device to its default position upon de-energization of the relay control device.

### BRIEF DESCRIPTION OF THE DRAWINGS

Exemplary embodiments of the present disclosure will be better understood and readily apparent to one of ordinary skill in the art from the following written description, by way of example only, and in conjunction with the drawings, in which:

FIG. 1A is a schematic drawing of a top view of a relay control device in an exemplary embodiment.

FIG. 1B is a schematic drawing of a side view of the relay control device of FIG. 1A in a direction X.

FIG. 1C is a schematic drawing of a front view of the relay control device of FIG. 1A in a direction Y.

FIG. 2A is a schematic drawing of a cross-sectional view of a modular contact device.

FIG. 2B is a schematic drawing of a cross-sectional view of the modular contact device detachably coupled to a relay control device.

FIG. 3A is a schematic drawing of a side view of a relay module in an exemplary embodiment.

FIG. 3B is a schematic drawing of a top view of the relay module of FIG. 3A,

FIG. 3C is a schematic drawing of a front view of the relay module of FIG. 3B in a direction Z.

FIG. 4A is a schematic drawing of a cross-sectional view of a relay control device detachably coupled to a modular contact device in an exemplary embodiment in a first state.

FIG. 4B is a schematic drawing of the cross-sectional view of the relay control device and the modular contact device of FIG. 4A in a second state.

FIG. 5A is a schematic drawing of a cross-sectional view of a relay control device detachably coupled to a modular contact device in an exemplary embodiment in a first state.

FIG. 5B is a schematic drawing of the cross-sectional view of the relay control device and the modular contact device of FIG. 5A in a second state.

FIG. 6 is a schematic flow chart for illustrating a method of controlling the state of a relay module in an exemplary embodiment.

### DETAILED DESCRIPTION

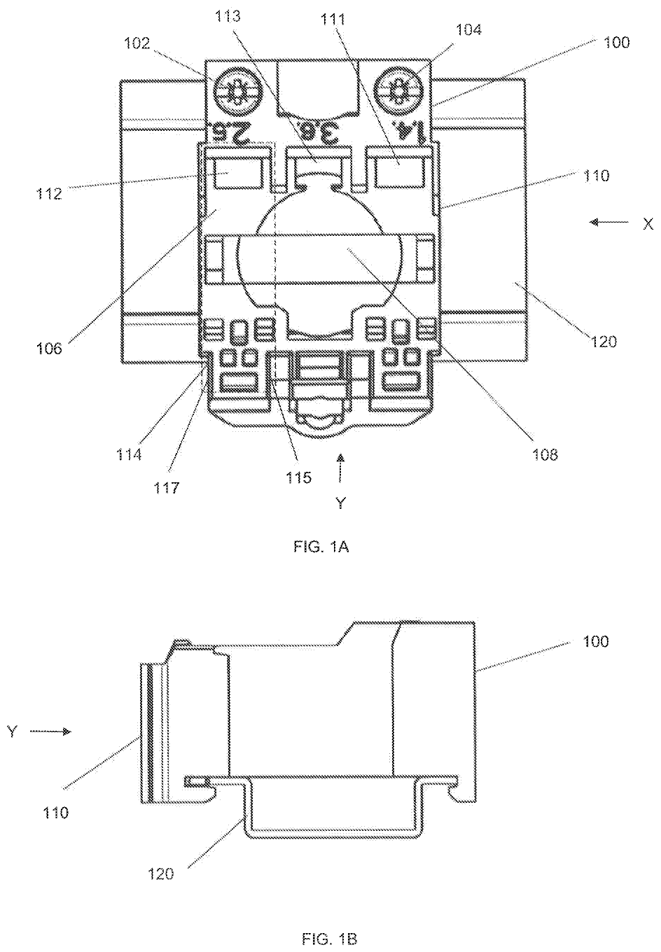

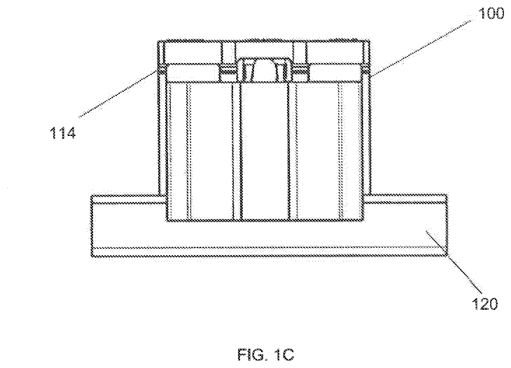

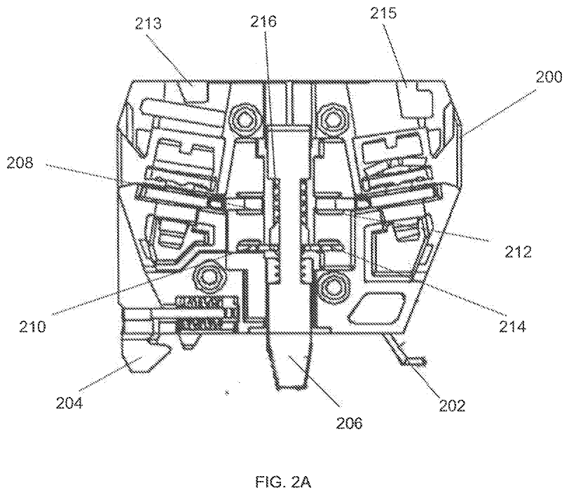

FIG. 1A is a schematic drawing of a top view of a relay control device 100 in an exemplary embodiment. FIG. 1B is a schematic drawing of a side view of the relay control device 100 of FIG. 1A in a direction X. FIG. 1C is a schematic drawing of a front view of the relay control device 100 of FIG. 1A in a direction Y.

In the exemplary embodiment, the relay control device 100 comprises power terminals 102, 104. The relay control device 100 is capable of being coupled to an energy source (not shown) via the power terminals 102, 104 for energizing the relay control device 100. The relay control device 100 also comprises one or more docks e.g. 106 (shown in dotted profile) and a recess 108 disposed in a housing 110 of the relay control device 100. In FIG. 1A, the relay control device 100 comprises three docks. Each dock e.g. 106 is specifically adapted to mate with a modular contact device (not shown). The dock e.g. 106 comprises a first mating portion 112 disposed on a top surface of a housing 110 of the relay control device 100. In the exemplary embodiment, the first mating portion 112 is in the form of an aperture 112. Substantially similar apertures 111, 113 are disposed for two other docks. The dock e.g. 106 may further comprise a second mating portion 114 disposed on another surface of the housing 110. For example, the second mating portion 114 can be a surface for a two-legged stiffened catch of the modular contact device. It is to be appreciated that the dock e.g. 106 is not limited as such. The first mating portion 112 and/or the second mating portion 114 may take any other form. For example, one or both of the first mating portion 112 and the second mating portion 114 may be a protruding element on the relay control device 100 to mate correspondingly with the modular contact device. For example, one or both of the first mating portion 112 and the second mating portion 114 may be a snap hook on the relay control device 100 to mate with the modular contact device. Thus, the dock e.g. 106 of the relay control device 100 employs a mechanically docking connection with the modular contact device and there is physical contact between the dock e.g. 106 and the modular contact device.

The recess 108 is adapted to receive or allow access to an actuating arm (also not shown) of the modular contact device. The access may be a through-hole access or may be provided by an indirect access. The recess 108 may be, but is not limited to, a trench that extends across the docks e.g. 106 of the relay control device 100. In some exemplary embodiments, an individual aperture may instead be provided for each dock e.g. 106 and disposed on the housing 110. Each aperture may allow access to the actuating arm of the modular contact device fitted or mated to the corresponding dock e.g. 106.

In the exemplary embodiment, there is no electrical contact disposed provided in the relay control device 100. The power terminals 102, 104 are for receiving power to energise the relay control device 100. Electrical contacts may be provided by one or more modular contact devices to be fitted t mated I docked to the relay control device 100. However, it is appreciated that in alternative exemplary embodiments, electrical contacts may also be provided in the relay control device 100 in addition to electrical contacts to be provided by the one or more modular contact devices to be fitted/mated/docked to the relay control device 100.

In the exemplary embodiment, the relay control device 100 is adapted to, but is not is limited to, be detachably coupled to a base 120. The base 120 may be a portion of a relay rack for supporting one or a plurality of relay modules e.g. as a power panel.

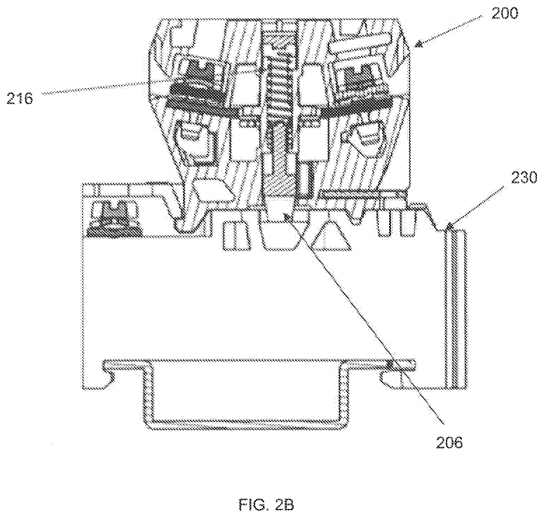

FIG. 2A is a schematic drawing of a cross-sectional view of a modular contact device 200 in one example. The modular contact device 200 may be detachably coupled to a relay control device (e.g. relay control device 100 of FIGS. 1A to 1C). The modular contact device 200 comprises a protruding part/appendage 202 adapted to mate with a first mating portion of a dock (e.g. the first mating portion 112 of FIG. 1A) of a relay control device, a connector 204 for detachably coupling to a second mating portion (e.g. the second mating portion 114 of FIG. 1A) of the relay control device, an actuating arm 206 disposed at a bottom surface of the modular contact device 200 and internal contacts e.g. 208, 210, 212, 214 disposed in the modular contact device 200. The protruding part/appendage 202 may additionally be in the form of a hook-like structure. The actuating arm 206 is coupled to a first contact 210 and a second contact 214. Displacement/movement of the actuating arm 206 translates to displacement of the first contact 210 and the second contact 214 in relation to a third contact 208 and a fourth contact 212 respectively.

The modular contact device 200 further comprises electrical contacts 213, 215 disposed on a top surface of the modular contact device 200. The electrical contacts may be coupled to an external device.

The electrical contacts 213, 215 derive electrical characteristics from the internal contacts e.g. 208, 210, 212, 214. For example, electrical contact 213 may be an earth terminal depending on the state of the internal contacts 208, 210 and electrical contact 215 may be a live terminal depending on the state of the internal contacts 212, 214. The electrical characteristics are also derivable based on connection to power terminals (e.g. power terminals 102, 104 of FIG. 1A) of the relay control device.

In this example, the internal contacts e.g. 208, 210, 212, 214 are configured to be normally open (NO). in other exemplary embodiments, the internal contacts e.g. 208, 210, 212, 214 may be normally closed (NC). Thus, the external electrical contacts 213, 215 in this exemplary embodiment are in a state of NO. The state of each set of internal contacts, e.g. the first contact 210 and the third contact 208, and the second contact 214 and the fourth contact 212, is caused to be mechanically changed by a push actuator/mechanism of the relay control device. In turn, the state of the electrical contacts 213, 215 is also changeable by the relay control device.

In this example, there is provided a spring member or a return spring that is biased against the push actuator/mechanism of the relay control device. FIG. 2A also shows in partial view an over-travel spring 216 that is capable of providing contact pressure to ensure adequate electrical contact e.g. between the internal contacts e.g. 208, 210, 212, 214.

The connector 204 may be, but is not limited to, for example a catch element or a snap hook element. In this example, the connector 204 is in the form of a two-legged stiffened catch that is capable of engaging the second mating portion (e.g. the second mating portion 114 of FIG. 1A). For example, the two-legged stiffened catch may be fitted or slotted to engage sidewalls (e.g. sidewalls 115, 117 of FIG. 1A).

FIG. 2B is a schematic drawing of a cross-sectional view of the modular contact device 200 detachably coupled to a relay control device 230 in another example. In this example, the modular contact device 200 is shown to comprise the over-travel spring 216.

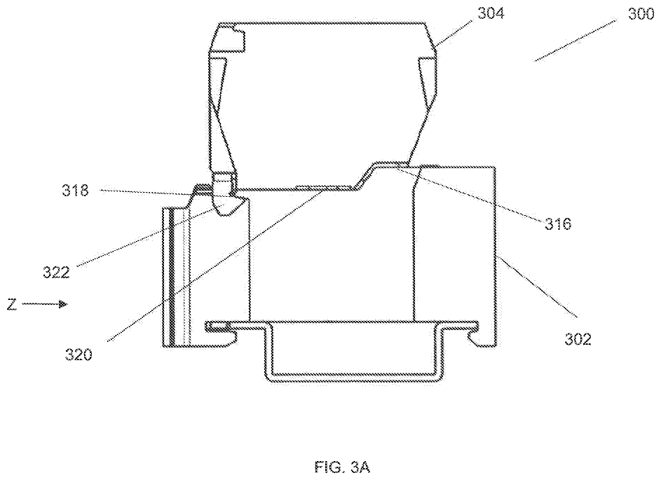

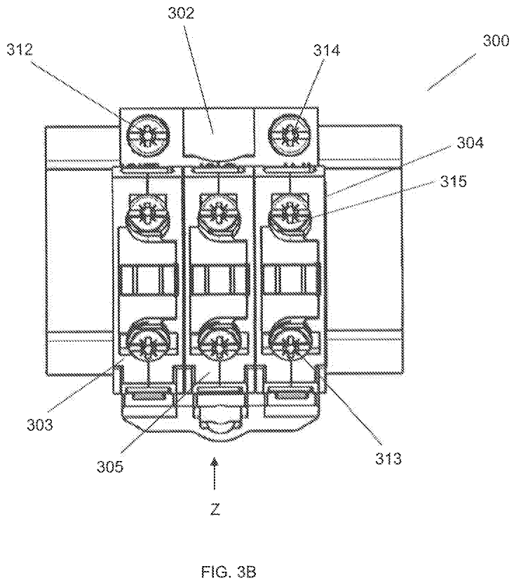

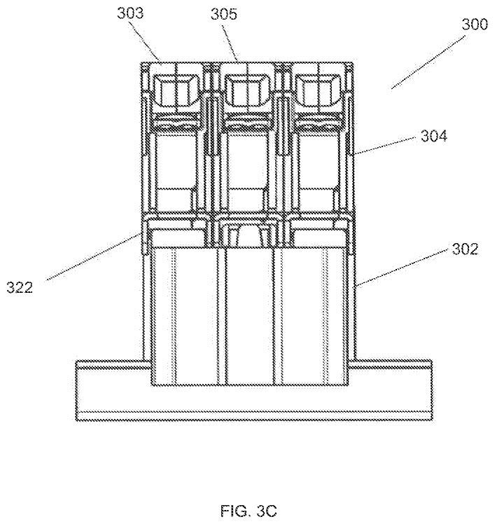

FIG. 3A is a schematic drawing of a side view of a relay module 300 in an exemplary embodiment. FIG. 3B is a schematic drawing of a top view of the relay module 300 of FIG. 3A. FIG. 3C is a schematic drawing of a front view of the relay module 300 of FIG. 3B in a direction Z.

In the exemplary embodiment, the relay module 300 comprises a relay control device 302 coupled to one or more modular contact devices e.g. 304. In this exemplary embodiment, there are three modular contact devices 304, 303, 305 being detachably coupled to the relay control device 302. The modular contact devices e.g. 304 may be normally open (NO) or normally closed (NC). It is not necessary for all of the modular contact devices e.g. 304, which are coupled to the relay control device 302, to be all NO or all C. For example, one modular contact device may be NO and the other two modular contact devices may be NC.

In the exemplary embodiment, the relay control device 302 is substantially similar to the relay control device 100 as described with reference to FIG. 1A. The modular contact devices 304, 303, 305 are each substantially similar to the modular contact device 200 as described with reference to FIGS. 2A and 2B.

The relay control device 302 is capable of being coupled to an energy source via coil/power terminals 312, 314 for energizing the relay control device 302. Each of the power terminals 312, 314 is coupled to a conductor (not shown) disposed in the relay control device 302. In turn, each modular contact device e.g. 304 provides a set of electrical contacts for use with an external circuit. For example, the modular contact device 304 comprises electrical contacts 313, 315 that have electrical characteristics derived from or in connection to the power terminals 312, 314 when the relay control device 302 is energised. For example, one of the electrical contacts 313, 315 may be a live terminal and the other of the electrical contacts 313, 315 may be an earth terminal.

In the exemplary embodiment, for the coupling of each of the modular contact device e.g. 304 to the relay control device 302, a protruding appendage (compare the protruding part/appendage 202 of FIG. 2A) of the modular contact device e.g. 304 is mechanically coupled/mated to a first mating portion 316 (compare the first mating portion 112 of FIG. 1A) of the relay control device 302. A connector 322 in the form of a two-legged stiffened catch of the modular contact device 304 is mechanically coupled to a second mating portion 318 of the relay control device 302. In the exemplary embodiment, the connector 322 is slotted downwards to fittingly engage sidewalls of the second mating portion 318.

In use, a push actuator/mechanism of the relay control device 302 is activated when the relay control device 302 is energised/powered up. An electromagnetic coil of an electromagnet disposed in a housing of the relay control device 302 cooperates with a core to provide a push actuator/mechanism that functions to displace an actuating arm of each of the modular contact devices 304, 303, 305. The actuating arm of each modular contact device e.g. 304 is disposed in a recess (schematically indicated at numeral 320) of the relay control device 302. The push actuator I mechanism of the relay control device 302 causes a change in the state of each modular contact device e.g. 304, for example from normally open (NO) to closed, or from normally closed (NC) to open.

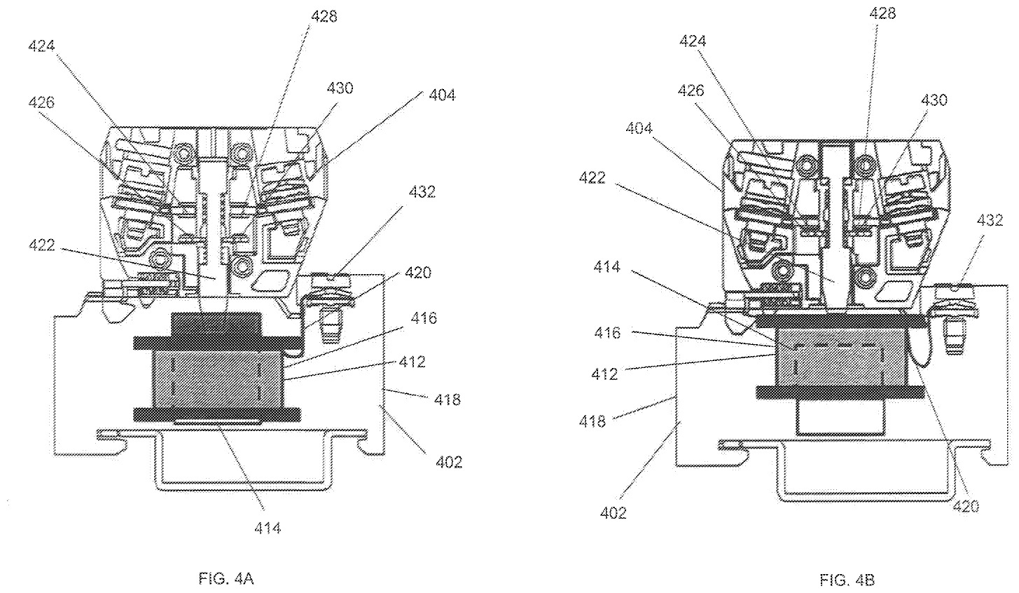

FIGS. 4A and 4B show one example of a push mechanism in an exemplary embodiment. FIG. 4A is a schematic drawing of a cross-sectional view of a relay control device 402 detachably coupled to a modular contact device 404 in an exemplary embodiment in a first state. FIG. 4B is a schematic drawing of the cross-sectional view of the relay control device 402 and the modular contact device 404 of FIG. 4A in a second state.

In the exemplary embodiment, an electromagnet 412 and a core 414 are disposed in a housing 418 of the relay control device 402. The electromagnet 412 comprises an electromagnetic coil 416. The coil 416 and the core 414 are configured to cooperate with each other upon energization of the relay control device 402 to provide a push mechanism of the relay control device 402. The core 414 is located at a stationary or fixed position in the relay control device 402. The push mechanism is provided by configuring the electromagnet 412 to be movable with respect to the core 414 when the relay control device 402 switches between an energized state and a de-energized state. The electromagnet 412 is maintained/returned to an initial position when the coil 416 is in a de-energized state or a first state, e.g. by a spring member of the modular contact device 404 (e.g. a return spring of the modular contact device 200 of FIGS. 2A and 2B). In this first state (as shown in FIG. 4A), there is no contact between an actuator arm 422 of the modular contact device 404 and a top surface of the electromagnet 412. There is also no contact between the actuator arm 422 and the core 414.

In the exemplary embodiment, a first conductor 420 and a second conductor (not shown) are each coupled to a first power terminal 432 and a second power terminal (not shown) respectively, for conducting current between the first power terminal 432 and the coil 416 and for conducting current between the second power terminal and the coil 416 respectively.

In the modular contact device 404 of this exemplary embodiment, first and second contacts 424, 426 are normally open (NO). Third and fourth contacts 428, 430 are normally open (NO). The modular contact device 404 is in a NO state with regard to electrical contacts being provided by the modular contact device 404 for connection to an external circuit (not shown).

To switch to the second state, current is provided to the electromagnet 412 via the first conductor 420 and the second conductor. When the relay control device 402 is coupled to an energy source and a predetermined amount of current flows through the coil 416 of the electromagnet 412, the electromagnet 412 is attracted to the core 414. The magnetic force causes the electromagnet 412 to move from its original position to align to a predetermined position with reference to the core 414. This movement of the electromagnet 412 contacts and pushes the actuating arm 422 of the modular contact device 404 (as shown in FIG. 4B). Displacement/movement of the actuating arm 422 translates to displacement of the second contact 426 and the fourth contact 430 which are connected to the actuating arm 422 in relation to the first contact 424 and the third contact 428 respectively. When the second contact 426 comes into contact with the first contact 424, the state of the first and second contacts 424, 426 changes to closed. When the third contact 428 comes into contact with the fourth contact 430, the state of the third and fourth contacts 428 and 430 changes from normally open to closed. Thus, the state of the modular contact device 404 is changed from normally open to closed. The relay module is caused to be energized and power is supplied to a device coupled to the electrical contacts of the modular contact device 404. In this exemplary embodiment, the core 414 remains fixed (i.e. is not movable).

When the current flowing through the coil 416 of the electromagnet 412 is switched off or falls below the predetermined amount, the electromagnet 412 moves back to its original position due to the spring member of the modular contact device 404. With the movement of the electromagnet 412 away from the actuating arm 422, the actuating arm 422 of the modular contact device 404 moves back to its initial position and the contacts are switched back to their default states (e.g. NO), as illustrated with FIG. 4A.

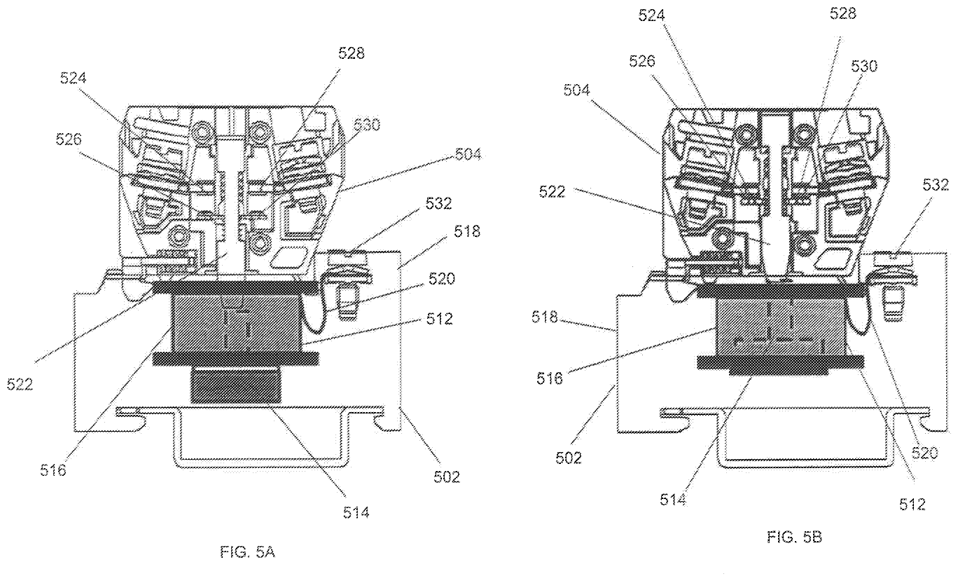

FIGS. 5A and 5B show another example of a push mechanism in an exemplary embodiment. FIG. 5A is a schematic drawing of a cross-sectional view of a relay control device 502 detachably coupled to a modular contact device 504 in an exemplary embodiment in a first state. FIG. 5B is a schematic drawing of the cross-sectional view of the relay control device 502 and the modular contact device 504 of FIG. 5A in a second state.

In the exemplary embodiment, an electromagnet 512 and a core 514 are disposed in a housing 518 of the relay control device 502. The electromagnet 512 comprises an electromagnetic coil 516. The coil 516 and the core 514 are configured to cooperate with each other upon energization of the relay control device 502 to provide a push mechanism of the relay control device 502. The electromagnet 512 is located at a stationary or fixed position in the relay control device 502. The push mechanism is provided by configuring the core 514 to be movable with respect to the electromagnet 512 when the relay control device 502 switches between an energized state and a de-energized state. The core 514 is maintained/returned to an initial position when the electromagnet 512 is in a de-energized state or a first state, e.g. by a spring member of the modular contact device 504 (e.g. a return spring of the modular contact device 200 of FIGS. 2A and 2B). In this first state (as shown in FIG. 5A), there is no contact between an actuator arm 522 of the modular contact device 504 and a top surface of the core 514. There is also no contact between the actuator arm 522 and the electromagnet 512.

In the exemplary embodiment, a first conductor 520 and a second conductor (not shown) are each coupled to a first power terminal 532 and a second power terminal (not shown) respectively, for conducting current between the first power terminal 532 and the coil 516 and for conducting current between the second power terminal and the coil 516 respectively.

In the modular contact device 504 of this exemplary embodiment, first and second contacts 524, 526 are normally open (NO). Third and fourth contacts 528, 530 are normally open (NO). The modular contact device 504 is in a NO state with regard to electrical contacts being provided by the modular contact device 504 for connection to an external circuit (not shown).

To switch to the second state, current is provided to the electromagnet 512. When the relay control device 502 is coupled to an energy source and a predetermined amount of current flows through the coil 516 of the electromagnet 512, the core 514 is attracted to the electromagnet 512. The magnetic force causes the core 514 to move from its original position to align to a predetermined position with reference to the electromagnet 512. This movement of the core 514 contacts and pushes the actuating arm 522 of the modular contact device 504 (as shown in FIG. 5B). Displacement/movement of the actuating arm 522 translates to displacement of the second contact 526 and the fourth contact 530 which are connected to the actuating arm 522 in relation to the first contact 524 and the third contact 528 respectively. When the second contact 526 comes into contact with the first contact 524, the state of the first and second contacts 524, 526 changes to closed. When the third contact 528 comes into contact with the fourth contact 530, the state of the third and fourth contacts 528 and 530 changes from normally open to closed. Thus, the state of the modular contact device 504 is changed from normally open to closed. The relay module is caused to be energized and power is supplied to a device coupled to the electrical contacts of the modular contact device 504. In this exemplary embodiment, the electromagnet 512 remains fixed (i.e. is not movable).

When the current flowing through the coil 516 of the electromagnet 512 is switched off or falls below the predetermined amount, the core 514 moves back to its original position due to the spring member of the modular contact device 504. With the movement of the core 514 away from the actuating arm 522, the actuating arm 522 of the modular contact device 504 moves back to its initial position and the contacts are switched to their default states (e.g. NO), as illustrated with FIG. 5A.

The inventors have recognised that the push actuator/mechanism may also be implemented using other methods or mechanisms. For example, the inventors have recognised that a see-saw mechanism may be implemented using a pivoting component coupled to the electromagnet and movement of the electromagnetic coil or core may actuate the see-saw mechanism. In addition, the maintaining or returning of the movable components (e.g. an electromagnet or a core) of a relay control device may be implemented using other methods or mechanisms. For example, a spring may be connected to the movable components to return the movable components to a default/original position in the absence/removal of a magnetic field.

In the described exemplary embodiments, the electrical contacts of the relay module are provided by one or more modular contact devices which are fitted/mated/docked to the relay control device.

In the described exemplary embodiments, the state of each set of electrical contacts of the relay module are therefore based on the state of each corresponding modular contact device which is fitted/mated/docked to the relay control device.

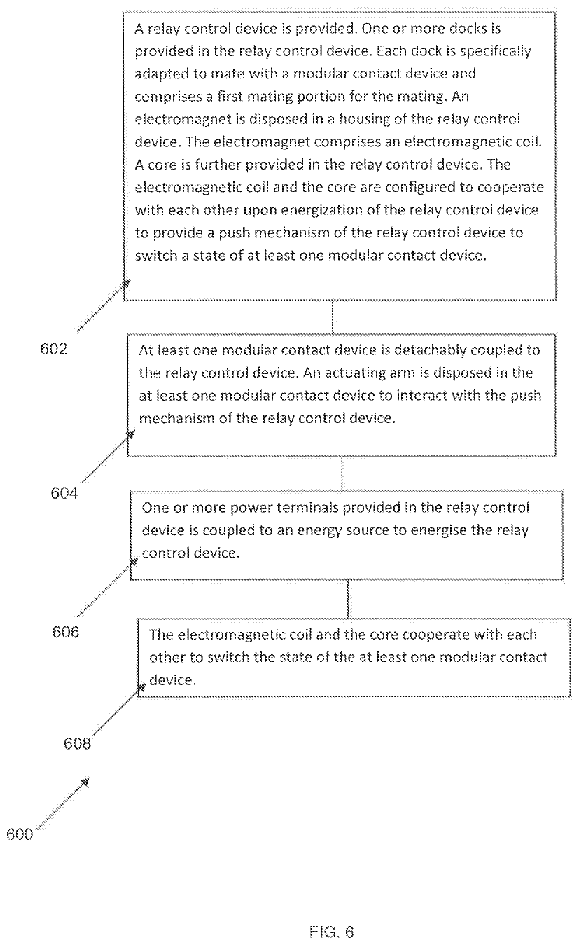

FIG. 6 is a schematic flow chart 600 for illustrating a method for controlling the state of a relay module in an exemplary embodiment. At step 602, a relay control device is provided. One or more docks is provided in the relay control device. Each dock is specifically adapted to mate with a modular contact device and comprises a first mating portion for the mating. An electromagnet is disposed in a housing of the relay control device. The electromagnet comprises an electromagnetic coil. A core is further provided in the relay control device. The electromagnetic coil and the core are configured to cooperate with each other upon energization of the relay control device to provide a push mechanism of the relay control device to switch a state of at least one modular contact device. At step 604, at least one modular contact device is detachably coupled to the relay control device. An actuating arm is disposed in the at least one modular contact device to interact with the push mechanism of the relay control device. At step 606, one or more power terminals provided in the relay control device is coupled to an energy source to energise the relay control device. At step 608, the electromagnetic coil and the core cooperate with each other to switch the state of the at least one modular contact device.

The push mechanism is configured to interact with the actuating arm of the at least one modular contact device to switch the state of the at least one modular contact device. The actuating arm of the at least one modular contact device is configured to be displaced by the push mechanism, to switch the state of the at least one modular contact device.

In some exemplary embodiments, the core is provided/located at a stationary position in the relay control device. The electromagnetic coil is configured to be movable with respect to the core from a default position when the relay control device switches between an energized state and a de-energized state to provide the push mechanism.

In some other exemplary embodiments, the electromagnet is provided/located at a stationary position in the relay control device. The core is configured to be movable with respect to the electromagnetic coil from a default position when the relay control device switches between an energized state and a de-energized state.

In some exemplary embodiments, a recess is disposed in the housing of the relay control device. The recess may extend across the one or more docks and is adapted to allow the push mechanism to switch the state of the at least one modular contact device.

In other exemplary embodiments, an aperture is provided for each dock and disposed on the housing of the relay control device.

In some exemplary embodiments, the first mating portion comprises an aperture disposed on a surface of the housing of the relay control device and is configured to mate with a corresponding appendage of the corresponding modular contact device. A protruding appendage adapted to mate with the first mating portion of the relay control device is provided for the at least one modular contact device. The protruding appendage of the at least one modular contact device is inserted into the corresponding first mating portion of the relay control device to detachably couple the at least one modular contact device to the relay control device.

A second mating portion of the dock may be further provided, wherein the second mating portion is disposed on the housing. The second mating portion may comprise at least two sidewalls of the housing configured to engage with a corresponding catch of the corresponding at least one modular contact device. A connector e.g. a two-legged catch of the modular contact device is also provided. The connector is coupled to the second mating portion to additionally detachably couple the at least one modular contact device to the corresponding dock of the relay control device.

The terms “coupled” or “connected” as used in this description are intended to cover both directly connected or connected through one or more intermediate means, unless otherwise stated.

Additionally, when describing some embodiments, the disclosure may have disclosed a method and/or process as a particular sequence of steps. However, unless otherwise required, it will be appreciated the method or process should not be limited to the particular sequence of steps disclosed. Other sequences of steps may be possible. The particular order of the steps disclosed herein should not be construed as undue limitations. Unless otherwise required, a method and/or process disclosed herein should not be limited to the steps being carried out in the order written. The sequence of steps may be varied and still remain within the scope of the disclosure.

Further, in the description herein, the word “substantially” whenever used is understood to include, but not restricted to, “entirely” or “completely” and the like. In addition, terms such as “comprising”, “comprise”, and the like whenever used, are intended to be non-restricting descriptive language in that they broadly include elements/components recited after such terms, in addition to other components not explicitly recited. Further, terms such as “about”, “approximately” and the like whenever used, typically means a reasonable variation, for example a variation of +/−5% of the disclosed value, or a variance of 4% of the disclosed value, or a variance of 3% of the disclosed value, a variance of 2% of the disclosed value or a variance of 1% of the disclosed value.

In the above described exemplary embodiments, the relay control device may function with at least one modular contact device. If there is any wear-and-tear or damage of the electrical contacts, the modular contact device with the damaged non-working electrical contacts may be replaced without replacing the relay control device. This improves convenience to the user. Additionally, lesser cost is involved in the replacement of the electrical contacts as more costly components such as the electromagnet may be retained,

The above described exemplary embodiments may also allow a user to increase the number of electrical contacts of a relay module, with usage of fewer relay control devices. When more electrical contacts are needed for a relay module, the user may add more modular contact devices to the relay module.

The above described exemplary embodiments may provide a double break in the at least one modular contact device. This provides a stronger breakage of electrical current in the relay module and improves the safety performance of the relay module.

The above described exemplary embodiments provide a push actuator/mechanism for switching a state of the at least one modular contact device. It is recognized by the inventors that a push mechanism is preferred to a pull-mechanism as pulling of contacts/actuating arm may require larger magnetic fields. A pull-mechanism may also weaken over time.

In the description herein, one or more docks of the relay control device may be provided. In the examples, three docks are described and shown in the figures but it will be appreciated that the number of docks is not limited as such and may include any number based on design of the relay control device.

For the described exemplary embodiments, to provide the push actuator/mechanism across multiple docks, it may be provided that the push actuator/mechanism is coupled to a planar component e.g. a bar or a substrate to interact with a plurality of actuating arms of one or more modular contact devices.

It will be appreciated by a person skilled in the art that other variations and/or modifications may be made to the specific embodiments without departing from the scope of the invention as broadly described. The present embodiments are, therefore, to be considered in all respects to be illustrative and not restrictive.

What is claimed is:

1. A relay control device for a relay module, the relay control device comprising,
one or more docks, each dock specifically adapted to mate with a modular contact device and comprising a first mating portion for the mating;
one or more power terminals for coupling an energy source to energise the relay control device;
an electromagnet disposed in a housing of the relay control device, the electromagnet comprising an electromagnetic coil; and
a core, wherein the electromagnetic coil and the core are configured to cooperate with each other upon energization of the relay control device to provide a push mechanism of the relay control device to switch a state of at least one modular contact device.

2. The relay control device as claimed in claim 1, wherein the push mechanism is configured to interact with an actuating arm of the at least one modular contact device to switch the state of the at least one modular contact device.

3. The relay control device as claimed in claim 1, further comprising,
the core being located at a stationary position in the relay control device; and
the electromagnetic coil being configured to be movable with respect to the core from a default position when the relay control device switches between an energized state and a de-energized state to provide the push mechanism.

4. The relay control device as claimed in claim 1, further comprising,
the electromagnet being located at a stationary position in the relay control device; and
the core being configured to be movable with respect to the electromagnetic coil from a default position when the relay control device switches between an energized state and a de-energized state to provide the push mechanism.

5. The relay control device as claimed in claim 1, further comprising a recess disposed in the housing, the recess extending across the one or more docks and being adapted to allow the push mechanism to switch the state of the at least one modular contact device.

6. The relay control device as claimed in claim 1, further comprising for each dock, an aperture disposed in the housing and adapted to allow the push mechanism to switch the state of the at least one modular contact device.

7. The relay control device as claimed in claim 1, wherein the first mating portion comprises an aperture disposed on a surface of the housing and configured to mate with a corresponding appendage of said modular contact device.

8. The relay control device as claimed in claim 1, wherein the dock further comprises a second mating portion disposed on the housing.

9. The relay control device as claimed in claim 8, wherein the second mating portion comprises at least two sidewalls of the housing configured to engage with a corresponding catch of said modular contact device.

10. A relay module comprising:
a relay control device of claim 1; and
at least one modular contact device detachably coupled to the relay control device, the modular contact device comprising:
an actuating arm disposed to interact with the push mechanism of the relay control device.

11. The relay module as claimed in claim 10, wherein the actuating arm is configured to be displaced by the push mechanism to switch the state of the at least one modular contact device.

12. The relay module as claimed in claim 10, wherein the at least one modular contact device further comprises a protruding appendage adapted to mate with the first mating portion of the corresponding dock of the relay control device.

13. The relay module as claimed in claim 10, wherein the modular contact device further comprises a two-legged catch for additionally detachably coupling to the corresponding dock of the relay control device.

14. The relay module as claimed in claim 10, wherein the actuating arm is configured to provide a switch in the state of the modular contact device based on a displacement of the actuating arm.

15. The relay module as claimed in claim 10, wherein the at least one modular contact device further comprises a spring member capable of returning the electromagnetic coil or the core of the relay control device to its default position upon de-energization of the relay control device.
